(19) United States
(12) Patent Application Publication
(10) Pub. No.: US 2026/0326608 A1
(43) Pub. Date: Oct. 22, 2026

(54) CHARGING APPARATUS FOR ELECTRIC VEHICLE USING ADDRESS AUTO-SETTING CHARGING MODULE AND CONTROL METHOD THEREOF

(71) Applicant: AHA CO., LTD., Gyeonggi-do (KR)

(72) Inventor: GI DO GOO, Gyeonggi-do (KR)

(21) Appl. No.: 19/105,095

(22) PCT Filed: Dec. 28, 2023
(86) PCT No.: PCT/KR2023/021801

§ 371 Date: Feb. 20, 2025

(30) Foreign Application Priority Data
Dec. 8, 2023 (KR) 10-2023-0178096

(51) Int. Cl. B60L 53/67; B60L 53/30

(52) U.S. Cl. CPC B60L 53/67; B60L 53/30

(57) ABSTRACT

A charging apparatus for electric vehicle uses an address auto-setting charging module and includes an address auto-setting unit configured to operate a plurality of charging modules and inserted into a port in a plug and play manner, and a charging unit configured to include the plurality of charging modules, recognize address information automatically set by the address auto-setting unit as its own address when charging of the electric vehicle starts, and operate at least one module of the plurality of charging modules to perform a charging operation.

### BACKGROUND

### 1. Technical Field

The present invention relates to a rapid charging apparatus for electric vehicle using an address (e.g., address or ID) auto-setting charging module (CM, Charging Module) and a control method thereof, more specifically, to a rapid charging apparatus for electric vehicle using an address auto-setting charging module and a control method thereof, in which, during rapid charging, a charging module to be used is selected with a designated address from among a plurality of charging modules built in the rapid charger, thereby performing charging.

### 2. Background Art

Currently, in order to charge a target power to be charged in a rapid charger for an electric vehicle, a driving control method corresponding to the configuration of the charging module is relied upon. For example, the control method of the charging module varies depending on the configuration circuit of the charger for electric vehicle, in the related art, most rapid chargers select a charging module to be used from among a plurality of built charging modules by selecting the address of charging module which is manually set at the time of manufacturing and installation.

In this way, when the charging module address is manually set, it takes time to manually set the charging module address during manufacturing and installation, and the charging module address needs to be managed for maintenance and system operation, which requires skilled knowledge and skills to operate the charging module, and causes a serious problem that the charging module may not be used when the charging module is set incorrectly.

In other words, in general, an address setting method for selecting the charging module for charging an electric vehicle is manually set when a product is manufactured by using a dual-inline package (DIP) switch or the like built in the charging module in most cases. This method of manually setting the address of charging module is very inconvenient because it requires the skilled necessary knowledge for address setting, the setting time required for charger manufacturing, and address management.

### SUMMARY

An object of the present invention is to provide a rapid charging apparatus for electric vehicle using an address auto-setting charging module in which, for example, during rapid charging, a charging module to be used is selected as a set address from among a plurality of charging modules built in a rapid charger to perform charging, and a control method thereof.

Objects of the present invention are not limited to the objects mentioned above, and other objects that are not mentioned will be clearly understood by those skilled in the art from the following description.

In order to solve the above problems, a charging apparatus for electric vehicle using an address auto-setting charging module according to an embodiment of the present invention includes: address auto-setting unit, configured to operate a plurality of charging modules, which are inserted into a port, in a plug and play manner; and a charging unit, configured to include the plurality of charging modules, recognize address information automatically set by the address auto-setting unit as its own address when charging of the electric vehicle starts, and operate at least one module of the plurality of charging modules to perform a charging operation.

The charging unit may utilize unique identification information assigned to the port as the address information.

Each of the charging modules may include: a first conversion circuit unit configured to convert a positive voltage (+V_{DC}), which is input to each of first inverter and second inverter, into an alternating voltage and current, then rectify it to output first power voltage and current, a second conversion circuit unit configured to convert a negative voltage (−V_{DC}), which is input to each of third inverter and fourth inverter, into an alternating voltage and current, then rectify it to output the second power voltage and current, and a switching circuit unit configured to operate the first conversion circuit unit and the second conversion circuit unit in series or in parallel to output a high voltage and high current equal to or greater than a reference by serially and parallelly combining the first power voltage and current and the second power voltage and current.

The rapid charging apparatus for an electric vehicle may further include a control unit configured to determine power distribution using the plurality of charging modules and a method of serial and parallel connection based on target power information related to target power for the charging when the charging starts, and to control the plurality of charging modules according to the determined result.

The charging unit may include a communication unit configured to receive unique identification information assigned to the port from the address auto-setting unit for each of the charging modules and transmit the received information to the control unit.

In order to solve the above problems, a driving method of a charging apparatus for electric vehicle using an address auto-setting charging module according to an embodiment of the present invention includes: operating, by an address auto-setting unit, a plurality of charging modules, which are inserted into a port, in the plug and play manner; and recognizing, by the charging unit configured to including the plurality of charging modules, address information automatically set by the address auto-setting unit as its own address when charging of electric vehicle is started, and operating at least one module of the plurality of charging module to perform charging operation.

Performing the charging operation may utilize unique identification information assigned to the port as the address information.

Performing the charging operation may include converting, by a first conversion circuit unit constituting each of the charging modules, a positive voltage (+V_{DC}) input to each of first inverter and second inverter into an alternating voltage and current, then rectifying it, to output first power voltage and current, converting, by a second conversion circuit unit constituting each of the charging modules, a negative voltage (−V_{DC}) input to each of third inverter and fourth inverter into an alternating voltage and current, then rectifying it, to output second power voltage and current, and operating, by a switching circuit unit, the first conversion circuit unit and the second conversion circuit unit in series or in parallel, to output a high voltage and high current equal to or greater than a reference by serially and parallelly combining the first power voltage and current and the second power voltage and current.

The driving method may further include determining, by the control unit, power distribution using the plurality of charging modules and a method of serial and parallel connection based on target power information related to target power for the charging when the charging starts, to control the plurality of charging modules according to the determined result.

The driving method may further include receiving, by a communication unit configured in the charging unit, unique identification information assigned to the port for each of the charging modules from the address auto-setting unit, to transmit the received information to the control unit.

According to an embodiment of the present invention, by using an address auto-setting charging module as address board in a plug and play manner capable of automatically recognizing the address of a charging module, it is possible to solve the problems of the conventional manual setting method, which requires skilled knowledge and expertise, necessitates address management of the charging module, making maintenance difficult, and renders the charging module unusable if incorrectly set.

In other words, according to an embodiment of the present invention, by flexibly controlling the automatic setting of charging modules in the plug and play manner capable of automatically recognizing the address of charging module among the plurality of charging modules built in rapid charger for electric vehicle, it is possible to facilitate the maintenance of the rapid charger without requiring skilled knowledge and skill and to solve the problem of the manual setting method, which renders the charging module unusable if incorrectly set.

The effects of the present invention are not limited to the above-mentioned effects, and other effects that are not mentioned will be clearly understood by those skilled in the art from the description of the claims.

### BRIEF DESCRIPTION OF THE DRAWINGS

FIG. 1 is an internal configuration diagram of a 60 kW rapid charger according to an embodiment of the present invention.

FIGS. 2A and 2B are diagrams for describing the address board of FIG. 1.

FIGS. 3A and 3B are overall flowcharts of data reading and writing of a charging module for charging an electric vehicle.

FIG. 4 is a configuration diagram of the address board of FIG. 1.

FIG. 5 is a circuit connection diagram of the address board of FIG. 4.

FIG. 6 is a configuration diagram of a charging module CM that generates a high output with a large number of low outputs.

FIG. 7 is a circuit connection diagram (or circuit diagram) of a charging module that generates a high output with a large number of low outputs.

FIG. 8 is a flowchart of a process of charging an electric vehicle via a rapid charger.

FIG. 9 is a flowchart of a process of checking a target power and proceeding with charging through an address board and a charging module according to an embodiment of the invention.

FIG. 10 is a flowchart illustrating a driving process of a (rapid) charging apparatus for electric vehicle according to an embodiment of the present invention.

### DETAILED DESCRIPTION

The present invention is not limited to the embodiments described below, but may be implemented in various forms different from each other, and these embodiments are merely illustrative of the contents of the present invention, and are provided to inform those skilled in the art to which the present invention pertains of the scope of the present invention in detail, and the present invention is defined only by the scope of the claims. Like numbers refer to like elements throughout the specification.

Embodiments described herein will be described with reference to cross-sectional and/or plan views, which are idealized illustrations of the invention. In the drawings, the illustrated regions are represented for effective description of the technical content. Accordingly, the regions illustrated in the figures have schematic nature, and the shapes of the regions illustrated in figures are intended to illustrate particular forms of device regions and are not intended to limit the scope of the invention. In various embodiments herein, although the terms first, second, third, etc. have been used herein to describe various components, these components should not be limited by these terms. These terms are merely used to distinguish one component from another. The embodiments described and illustrated herein also include complementary embodiments thereof.

The terminology used herein is for the purpose of describing embodiments only and is not intended to be limiting of the invention. In this specification, the singular form includes the plural form unless otherwise explicitly stated. The terms “comprises” and/or “comprising,” as used herein, do not preclude the presence or addition of one or more other components, steps, operations, and/or elements to the recited component, step, operation, and/or element.

Unless otherwise defined, all terms (including technical and scientific terms) used herein have the same meaning as commonly understood by one of ordinary skill in the art to which this invention belongs. In addition, terms defined in commonly used dictionaries are not to be construed as ideal or excessive unless explicitly and specifically defined.

Hereinafter, the concept of the present invention and embodiments thereof will be described in detail with reference to the drawings.

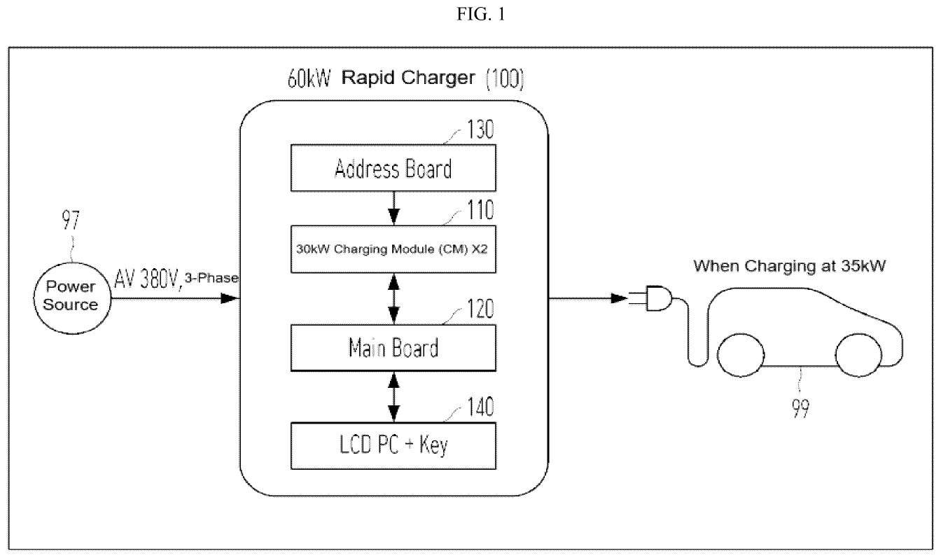

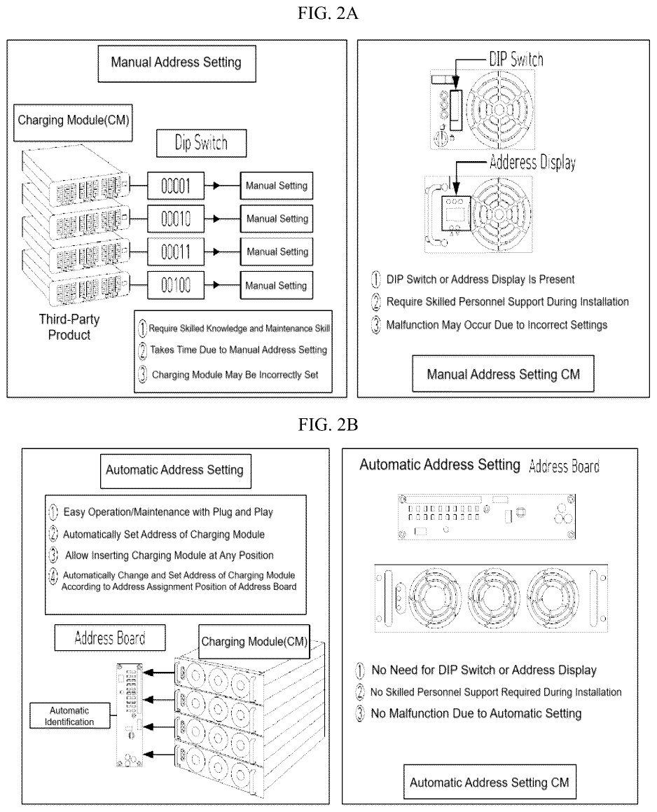

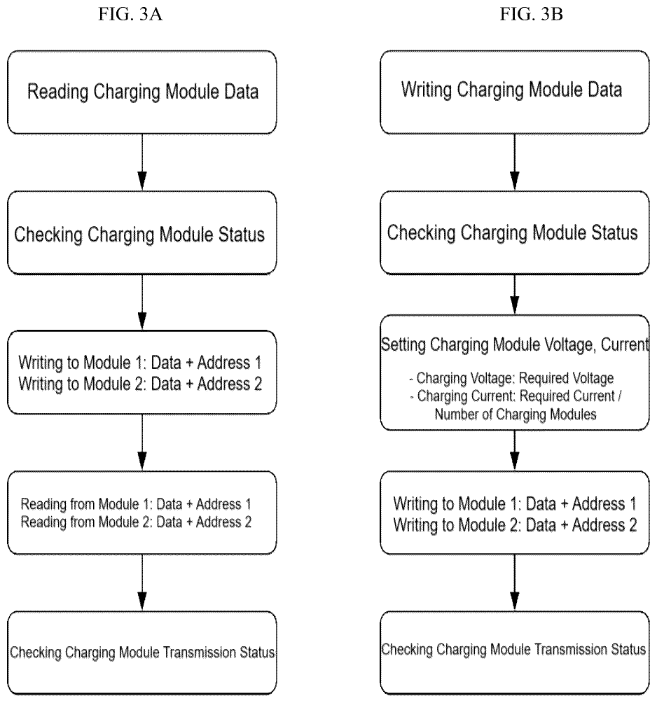

FIG. 1 is an internal configuration diagram of a rapid charger according to an embodiment of the present invention; FIGS. 2A and 2B are diagrams for describing the address board of FIG. 1; and FIGS. 3A and 3B are overall flowcharts of data reading and writing of a charging module for charging an electric vehicle.

As shown in FIG. 1, a (rapid) charger (or charging apparatus) 100 according to the embodiment of the present invention is a 60 kW rapid charger exemplifying a case of charging an electric vehicle by 35 kW using a 60 kW electric vehicle rapid charger, and includes a charging unit 110, a main board unit (or a control unit) 120, an address board unit (or an address (automatic) setting unit) 130, and an interface unit 140, and may further include a power supply unit (SMPS), or a charging voltage output unit, and the like.

Herein, “including some or all” means that some components, such as the power supply unit or the charging voltage output unit, may be separated from the rapid charger 100 and configured as a separate apparatus, or that the charging modules constituting the charging unit 110 may be integrated into the main board unit 120 or the address board unit 130, for the purpose of providing a thorough understanding of the invention, the description assumes that all components are included.

The rapid charger 100 according to the embodiment of the present invention, for example, as a 60 kW rapid charger, may receive AC 380V three-phase input power and perform 35 kW charging to an electric vehicle 99 through an address board for controlling charging modules, two 30 kW charging modules, and a coupler. Here, a coupler means a component used to transfer energy from one circuit to another, for example, but may be used in various meanings. In other words, it may mean a coupler that couples devices that are physically separated from each other to each other. Of course, the embodiments of the present invention will not be particularly limited to such a concept.

More specifically, the charging unit 110 according to the embodiment of the present invention may be configured to include two or more charging modules, and may include the charging module capable of charging 30 kW. For example, in order to correspond to various types (or product models) of the electric vehicle 99, the charging module may operate alone or operate in combination (e.g., serial or parallel coupling) of two charging modules to output more than 30 kW of power. This may correspond to an electric vehicle 99 that uses a variety of electric power. The internal configuration of the charging module will be described in more detail later. Commonly, the power P may be expressed as a product of the voltage V and the current I, but in the embodiment of the present invention, the energy source of the electric vehicle such as the voltage, the current, and the electric power may also be referred to as the power.

The charging unit 110 outputs a charging voltage to the electric vehicle 99 through a charging voltage output unit (e.g., a charging terminal), but each charging module may operate under the control of a processor, for example, such as CPU, MPU, or GPU configured in the main board unit 120. In other words, the charging port of the electric vehicle 99 is electrically (or circuitly) connected to the charging terminal through the connector or the like of the charging cable provided in the rapid charger 100, and in this case, it is also possible to determine what type of electric vehicle it is by receiving information on the type, model, or specification of the electric vehicle 99 based on the device identification information or the like of the electric vehicle 99. Accordingly, the main board unit 120 may control at least one charging module such that power of an appropriate voltage or current is provided to the electric vehicle 99. It is possible to convert and output low power to high power without generating heat or the like depending on the serial or parallel driving of the charging modules. The operation of converting and outputting low output into high output without generating heat or the like may be another technology according to the embodiment of the present invention, rather than automatically setting address information of the charging module by using the address board. The contents related to the charging module will be described in detail later.

The main board unit 120 may include a processor, for example, such as CPU, MPU, or GPU, and may operate in conjunction with an interface unit 140, for example, such as a communication interface unit or a user interface unit to which signal such as user command is input. For example, the main board unit 120 may receive various information related to the user's charging of the electric vehicle 99 through a display unit provided in a kiosk-type device or various types of devices constituting the rapid charger 100. For example, when authentication for use of the rapid charger 100 is required, an operation for authentication may also be performed. For example, when a password is set, an input operation thereof may also be performed. In addition, the interface unit 140 enables near field communication (NFC) to allow the user of the electric vehicle 99 to perform operations such as authentication or payment by running, for example, an application (hereinafter, app) on their smartphone or the like. The main board unit 120 may perform various operations in conjunction with the interface unit 140 and process data accordingly.

For example, when the main board unit 120 is linked to a monitoring device that monitors and manages the rapid charger 100 installed at various locations online, it may also transmit data related to the operation of the rapid charger 100 to the corresponding monitoring device, for example, a server such as a cloud server. Such monitoring operation may be representative of a malfunction of the rapid charger 100. When the malfunction occurs, the operation of that rapid charger 100 may be stopped and repairs made. It also monitors the real-time operation of the rapid charger 100 to predict malfunction. This prediction may be carried out by analyzing the operational data of the rapid charger 100 through an artificial intelligence (AI) program installed on the server and making predictions based on the analysis results. Of course, for prediction, that server may learn and train various learning data, and then perform a prediction operation based on the learning result.

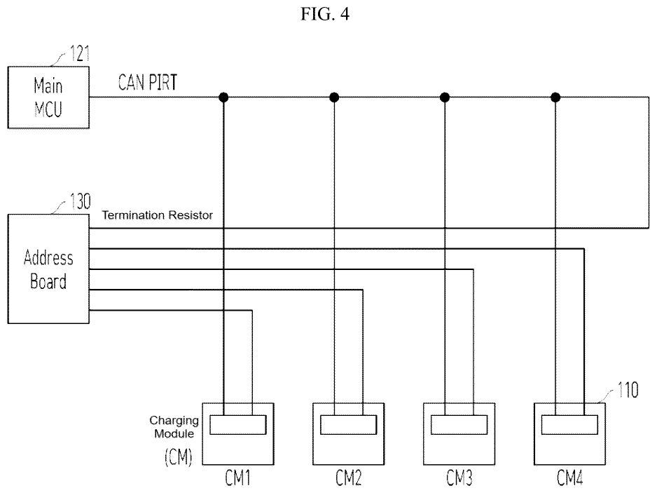

The address board unit 130 operates to automatically set addresses (information) for the plurality of charging modules constituting the charging unit 110. In FIG. 1, the address board unit 130 is illustrated as being connected only to the charging module of the charging unit 110; however, in practice, it is preferable that the address board unit 130 be connected to the main board unit 120 as in FIG. 4, and it is also entirely possible for it to be configured in a form integrated into the main board unit 120. Commonly, the board refers to the circuit board (e.g., a PCB) and may also refer to a card-shaped substrate that is inserted into a slot. Therefore, the main (or main) board may be a main PCB, and the address board unit 130 may be a sub (or secondary) PCB.

The address board unit 130 according to the embodiment of the present invention may operate in a plug and play manner of manual address setting or automatic address setting, as shown in FIGS. 2A and 2B. Here, the plug and play means that the device may be used immediately upon connecting power to the plug, which is identical or similar to the function that allows a computer to be used immediately without any additional user operation once the power is connected. Therefore, in the embodiment of the present invention, when the charging module is inserted into the address board, the procedure for separately assigning address information to the charging module may be unnecessary. The address board unit (130) may automatically set the address of the charging module, and it is entirely possible to insert the charging module at any arbitrary position. The address of the charging module may be automatically changed and set according to the address assignment position of the address board. Of course, it may be manually changed as much as possible, so there is no particular limitation on any one manner in the embodiments of the present invention. For example, the address board designates location identification information (e.g., port number, etc.) in a default manner for a type of port into which the charging module is inserted, and based on this, the identification information of the charging module may be automatically assigned. Of course, like the main board, the address board may also include a processor such as a CPU or MPU to control and manage the address information of the charging modules inserted at various positions. The operations related to the address board will be examined further later.

FIGS. 3A and 3B are diagrams illustrating a charging flow of reading/writing data of the charging module from a charging start to a charging end during charging of the electric vehicle according to the embodiment of the present invention. The start of charging involves preparing for charging by checking the voltage switch, power meter, two 30 kW charging modules, and the communication status and operation status of a power line communication (PLC) modem in the charger 100, by performing initial information and authentication between the electric vehicle 99 and the charger using the PLC modem to exchange information on the maximum voltage and current of the charger 100, and then by applying power to the two charging modules for charging. After applying power to the charging module, the voltage/current applied between the electric vehicle 99 and the charger 100 is applied in steps of DC 800V/5 A, DC 800V/15 A, and DC 800V/25 A to verify insulation during charging between the charger 100 and the electric vehicle 99, then, charging starts with DC 800V/35 A, and when the preset charging completion condition is reached, charging is completed.

In addition to the above content, the contents related to the charging unit 110, the main board (unit) 120, the address board (unit) 130, and the interface unit 140 of FIG. 1, and furthermore, the power supply unit (SMPS) and the charging voltage output unit will continue to be dealt with later, and thus, the details are hereby replaced with those subsequent contents.

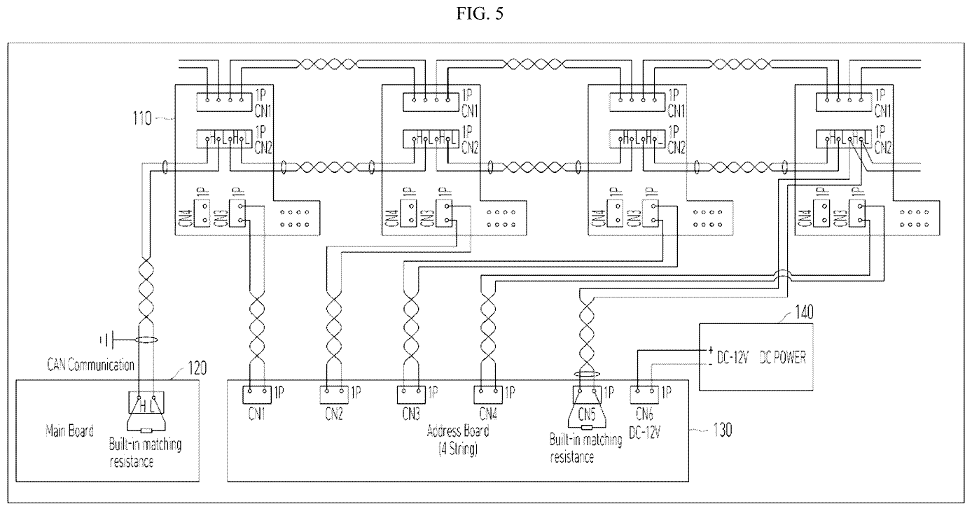

FIG. 4 is a configuration diagram of the address board of FIG. 1, and FIG. 5 is a circuit connection diagram of the address board of FIG. 4.

The address board according to the embodiment of the present invention may be configured in a form of automatically setting four charging modules with one address board. Referring to the configuration diagram of the address board shown in FIG. 4 and the circuit diagram shown in FIG. 5, charging module address auto-setting method (or operation) in the plug and play manner that may automatically recognize the address of the charging module, is implemented by the charging module being connected to and used with the Main MCU 121 of the main board (unit) 120 in FIG. 1 via CAN communication, wherein the address board has the unique address for each port (e.g., 4, 8, 12, etc.), and the charging module connected to this port acquires the address provided by that port, and, of course, the charging module itself does not have an inherent address but recognizes the address provided by the address board as its unique address. Accordingly, the connection address of the address board connected to the charging module becomes the unique address of the charging module, and this address is continuously transmitted periodically. Of course, the unique address information may be configured and used in formats such as 8-bit or 16-bit using binary bits of 1 and 0. This may be regarded as operating according to a type of communication protocol for data processing within the device.

Briefly describing the operation sequence, when the power of the charger 100 in FIG. 1 is turned on (ON), the charging module completes the initialization process, receives the address from the address board, recognizes it as its own address, and communicates with the Main MCU 121 (via CAN). The Main MCU 121 transmits the address of the charging module for proceeding with initialization to use the charging module, proceeds with the initialization, and then operates the charging module.

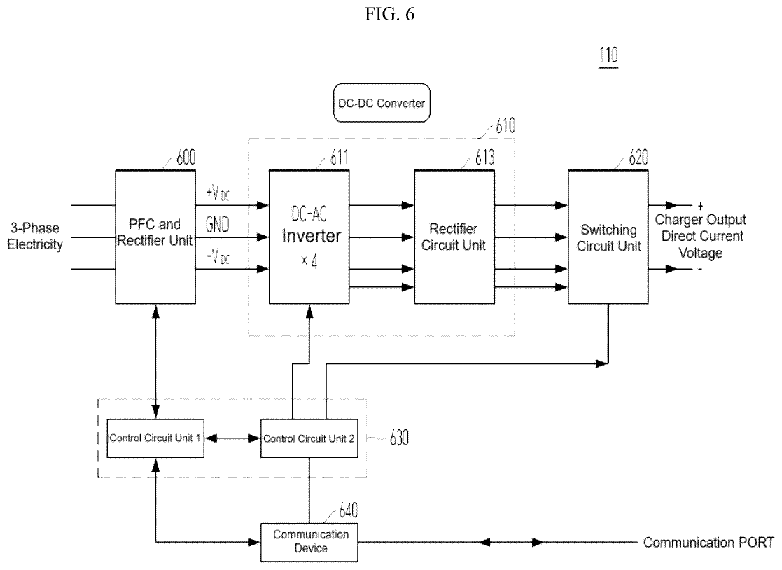

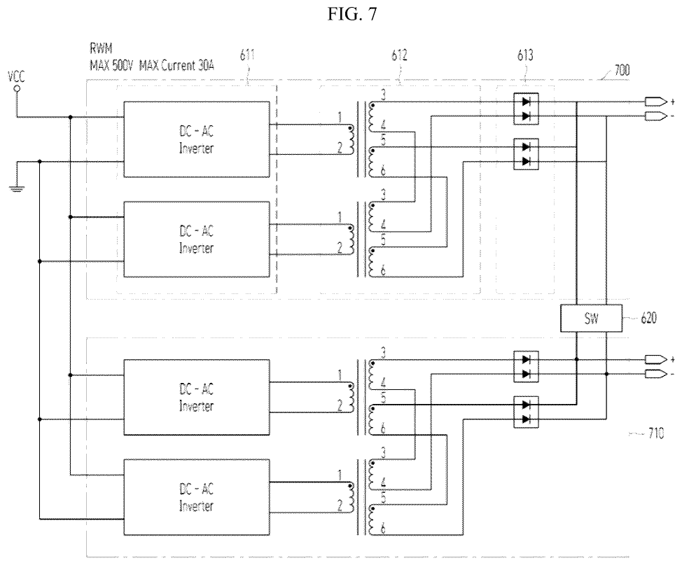

FIG. 6 is a configuration diagram of the charging module that generates a high output with a large number of low outputs, and FIG. 7 is a circuit connection diagram (or circuit diagram) of the charging module that generates the high output with the large number of low inputs.

The charging module 110 according to the embodiment of the present invention includes part or all of a power factor correction (PFC) and rectifier unit 600, DC-DC converter 610, switching circuit unit 620, control unit 630, and communication device (or communication unit) 640, wherein “including part or all” is not greatly different from the foregoing meaning, so those contents will be used instead.

In the embodiment of the present invention, as in FIG. 6, the charging module that generates high output with the plurality of low outputs may be used, making it possible to increase efficiency in power consumption of the charging apparatus and control the target output in various ways, and this charging module may use a PFC circuit to compensate for losses occurring during the rectification process for improvement of 3-phase interchange. In the 3-phase rectifier circuit at the 3-phase interchange input stage, a direct current voltage of a positive power source of (+) and (−) voltages is generated, and used as the direct current voltage provided to the DC-AC inverter and the power source for driving the PFC.

As shown in FIGS. 6 and 7, the DC-DC converter 610 may include four DC-AC inverters 611 and a rectifier circuit unit 613 connected to output stage thereof. Of course, the DC-AC inverter 610 and the rectifier circuit unit 613 may operate under the control of the control unit 630, and of course, if that control unit 630 is configured to be integrated into the main board unit 120 of FIG. 1, it may be controlled by a processor such as MPU on that main board unit 120. Regarding the circuit configurations of the DC-AC inverter 611 and the rectifier circuit unit 613 are well shown in FIG. 7, so those contents will be used instead.

However, in brief, the DC-AC inverter 611 may be configured with a total of four inverters. And, at the output stage of the inverter 611, first to fourth transformers may each be connected. The voltage and current input to each transformer 612 may be output through a multi-stage output stage, and the output voltage or current may be rectified and then combined in series or parallel by the switching circuit unit 620 before being output. The specific connection relationships between the elements are substituted with the diagram in FIG. 7.

In the embodiment of the present invention, the plurality of inverters 611 are used to distribute the load applied to the inverters 611, so that the efficiency with respect to the used power may be increased, and heat generation occurring in the inverter 611 may be minimized. That is, the rectified DC power sources obtained by the low voltage and low current inverters 611 are applied with a method of increasing the voltage or increasing the current through a series-parallel combination, so that it is possible to configure the charging module capable of effectively controlling the voltage and the current to obtain a target power.

Referring to FIG. 7, further examining the charging module circuit and operation for generating high output with the plurality of low outputs according to the embodiment of the present invention, the first conversion circuit 700 may convert a positive constant voltage (+V_{DC}), which is input to each of first inverter and second inverter, into an alternating voltage and current, then rectifies it to output first power voltage and current, the second conversion circuit 710 may convert a negative constant voltage (−V_{DC}), which is input to each of third inverter and fourth inverter, into alternating voltage and current, then rectify it to output the second power voltage and current, the switching circuit unit 620 may operate the first conversion circuit unit and the second conversion circuit unit in series or in parallel to output a high voltage and high current equal to or greater than the voltage supplied from each low output module by series-parallel combining the first power voltage and current and the second power voltage and current.

That is, by using a plurality of inverters to distribute loads applied to the inverters, efficiency with respect to used power may be increased, and heat generation occurring in the inverters may be minimized. This controls the charging module to obtain the target power for charging an electric vehicle from charging module by effectively controlling the voltage and current through the application of a method that increases voltage or enhances current via the series-parallel combination of rectified direct current power sources obtained through inverters of low voltage and low current.

As a result of the above configuration, according to the embodiment of the present invention, with the automatic address setting address of the charging module, which is capable of automatic recognition in the plug and play manner, by using multiple inverters to distribute the load applied to the inverters, power usage efficiency may be increased, heat generation in the inverters may be minimized, and by applying a method of increasing voltage or enhancing current through the series-parallel combination of rectified direct current power sources obtained through inverters of low voltage and low current, voltage and current may be effectively controlled to obtain target power, thereby controlling the charging module to implement a system capable of maximizing the charging efficiency of the rapid charger for electric vehicles while enabling flexible and convenient operation control and maintenance.

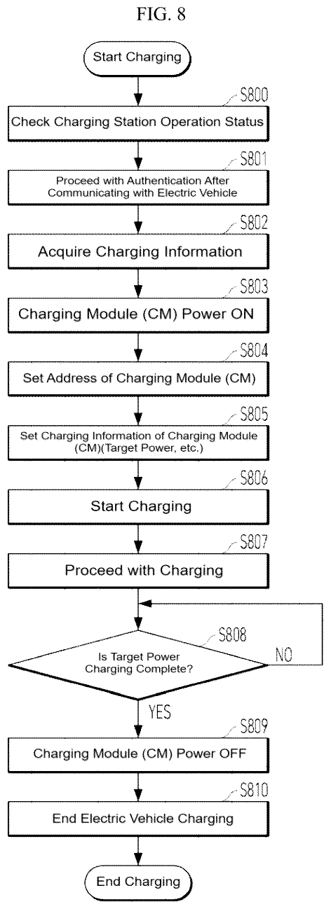

FIG. 8 is a flowchart of a process of charging the electric vehicle via a rapid charger.

For convenience of description, referring to FIG. 8 together with FIG. 1, first, whether the charger 100 may operate is checked (S800), and if there is no issue, the charger 100 authenticates through CAN communication with the electric vehicle and verifies the charging information (S801, S802). In this process, the charger 100 may also acquire charging information from the electric vehicle 99.

Next, the charger 100 turns on (ON) the charging module for charging and sets an address, to complete the charging information setting of the charging module and star charging (S803 to S806).

In the charging process, the authentication process of electric vehicle is checked, and when the set target power is reached, the charging module is turned off (OFF), and charging of the electric vehicle is terminated (S807 to S810).

Of course, during charging of the electric vehicle, data reading/writing of the charging module may be performed from the start of charging to the end of charging. This has already been seen in FIGS. 3A and 3B. Briefly reviewing again, the start of charging involves preparing for charging by checking the voltage switch, power meter, two 30 kW charging modules, and the communication status and operation status of the PLC modem in the charger, by performing initial information and authentication between the electric vehicle and the charger using the PLC modem to exchange information on the maximum voltage and current of the charger, and then by applying power to the two charging modules for charging. After applying power to the charging module, the voltage/current applied between the electric vehicle and the charger is applied in steps of DC 800V/5 A, DC 800V/15 A, and DC 800V/25 A to verify insulation during charging between the charger and the electric vehicle, then, charging starts with DC 800V/35 A, and when the preset charging completion condition is reached, charging is completed.

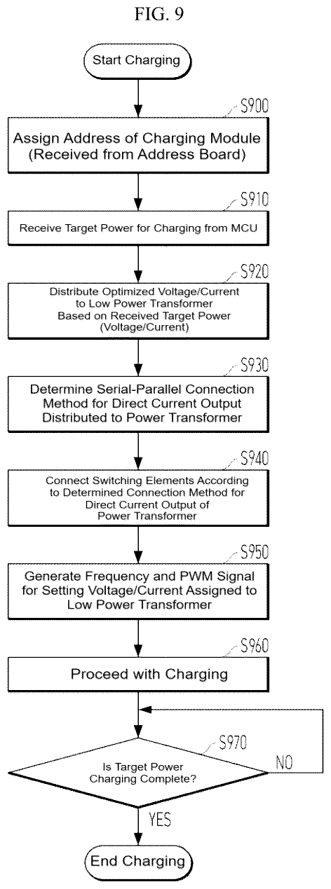

FIG. 9 is a flowchart of a process of checking target power and proceeding with charging through address board and charging module according to an embodiment of the invention.

For convenience of description, referring to FIG. 9 together with FIG. 1, when charging is started, the address board first assigns the address of the charging module (e.g., received from the address board), and then receives the target power (voltage/current) for charging from the MCU configured in the main board, for example (S900, S910). More precisely, the target power information related to the target power may be considered to be received from the MCU.

In addition, for example, the charging apparatus 100 or the address board distributes the target power as optimized voltage/current to the low-power converter according to the received voltage/current, and determines the series-parallel connection method for the direct current output distributed to the power converter (S920, S930). Of course, regarding the series-parallel connection method, settings may be configured in advance through programming before using the address board or the main board, and accordingly, when specific conditions (e.g., target power) are satisfied, voltage/current may be distributed and the method for series-parallel connection may be determined based on a default, preconfigured scheme.

Furthermore, the charging apparatus 100 connects the switching element (relay) according to the determined direct current output connection method of the power converter, generates the frequency and pulse width modulation (PWM) signal for setting the voltage/current assigned to the low power converter, and starts charging accordingly, and ends charging when the target power is charged (S940 to S970).

Of course, in this process, applying a lookup table (LUT) is also fully possible in the embodiment of the present invention. For example, if the value of the (pre)set voltage/current is inputted to the input stage of the LUT in the form of binary bits, the output thereof is such that the frequency and the control data of the PWM signal are matched and stored. Accordingly, the charging apparatus 100 may start charging to reach the target power by controlling the low power converter (e.g., see, FIGS. 6 and 7) based on the control data of the frequency and the PWM signal output from the LUT, and may end the charging operation when the charging is completed.

In addition to the above content, the charging apparatus 100 according to the embodiment of the present invention including the address board may perform various operations, and other details have been sufficiently explained earlier, so those contents will be used instead.

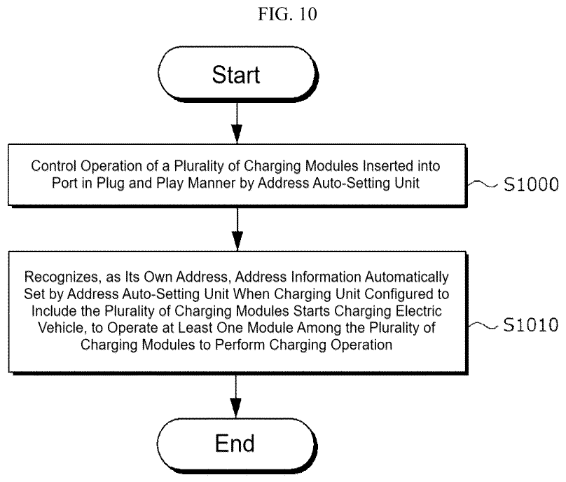

FIG. 10 is a flowchart illustrating a driving process of charging apparatus for electric vehicle according to an embodiment of the present invention.

For convenience of description, referring to FIG. 10 together with FIG. 1, the charging apparatus 100 for electric vehicle according to the embodiment of the present invention operates the plurality of charging modules inserted into ports of board in the plug and play manner, for example, as a rapid charging apparatus (S1000). Here, the plug and play may mean that when the charging module is inserted into the board of the automatic address setting unit, unique (identification) information of the inserted port, the number of the port, or the like is used as address information of the charging module inserted into the port, so that the charging operation is performed.

In addition, when charging of the electric vehicle is started, the charging apparatus 100 for electric vehicle may recognize address information automatically set by address auto-setting unit such as address board as its own address, and operate at least one module among a plurality of charging modules to perform the charging operation of electric vehicle (S1010). For example, each charging module inserted into a port may recognize unique information of the port as its own address information and transmit the address information to processor such as CPU or MPU that controls the charging operation of the charging module. And, the processor may combine at least one of the plurality of charging modules in series or in parallel based on the address information of the corresponding charging module to convert low power into high power equal to or greater than reference and charge the electric vehicle.

In addition to the above content, the charging apparatus 100 for electric vehicle of FIG. 1 may perform various operations, and other details have been sufficiently explained earlier, so those contents will be used instead.

Meanwhile, even though all the components constituting the embodiments of the present invention have been described as being combined into one or operating in combination, the present invention is not necessarily limited to such embodiments. That is, as long as it falls within the scope of the objectives of the present invention, all components may selectively couple and operate with one or more elements. Additionally, while all components may be implemented as independent hardware, some or all of the components may also selectively combine and be implemented as a computer program having program modules that perform some or all of the combined functions on one or more pieces of hardware. Codes and code segments making up the computer program will be readily derivable by one skilled in the technical field of the present invention. Such computer program may be stored in a non-transitory computer readable medium, read and executed by a computer, thereby implementing the embodiments of the present invention.

Here, the non-transitory readable recording medium refers to a medium that semi-permanently stores data and may be read by a device, rather than a medium that stores data for a short time, such as a register, a cache, or a memory. Specifically, the above-described programs may be stored and provided in a non-transitory readable recording medium such as CD, DVD, hard disc, Blu-ray disc, USB, memory card, ROM, or the like.

Although the preferred embodiments of the present invention have been shown and described above, the present invention is not limited to the specific embodiments described above, and various modifications may be made by those skilled in the art to which the present invention pertains without departing from the gist of the present invention as claimed in the claims, and these modifications should not be individually understood from the technical idea or prospect of the present invention.

1. A charging apparatus for electric vehicle using an address auto-setting charging module, comprising:
an address auto-setting unit configured to operate a plurality of charging modules, the address auto-setting unit inserted into a port in a plug and play manner; and
a charging unit configured comprising the plurality of charging modules, the charging unit configured to:
recognize address information automatically set by the address auto-setting unit as its own address when charging of the electric vehicle starts; and
operate at least one module of the plurality of charging modules to perform a charging operation,
wherein the charging unit utilizes unique identification information assigned to the port as the address information.

2. The charging apparatus for electric vehicle using an address auto-setting charging module according to claim 1, further comprising:
a control unit; configured to:
determine power distribution using the plurality of charging modules and a serial and parallel connection method, based on target power information related to target power for charging when the charging starts; and
control the plurality of charging modules according to the determined result.

3. The charging apparatus for electric vehicle using an address auto-setting charging module according to claim 1, wherein the charging unit comprises: a communication unit configured to:
receive unique identification information assigned to the port from the address auto-setting unit for each of the charging modules; and
transmit the received information to the control unit.
